(19) United States
(12) Patent Application Publication
(10) Pub. No.: US 2007/0170249 A1
(43) Pub. Date: Jul. 26, 2007

(54) Vending machine with dispensing units controlled directly without controller board

(75) Inventor: Robert J. Rademacher, Cortland, NY (US)

Correspondence Address: BERNHARD P. MOLLDREM, JR., 224 HARRISON STREET, SUITE 200, SYRACUSE, NY, 13202, US

(73) Assignee: VendPIN LLC.

(21) Appl. No.: 11/337,719

(22) Filed: Jan. 23, 2006

(51) Int. Cl. G06F 7/08

(52) U.S. Cl. 235/381

(57) ABSTRACT

A vending machine permits a customer to purchase phone cards or other merchandise articles from a plurality of article dispenser units. A cabinet contains a host computer, a customer interface device such as a touch screen monitor, and a credit card acceptor or cash acceptor for receiving payment from the customer. Each article dispenser unit within the cabinet containing a supply of merchandise articles, and has a motor or actuator for dispensing one of said articles per cycle upon command from the computer; a connector receiving a respective serial cable coupled to the host computer; and an internal circuit board for recognizing control signals addressed to the dispenser unit and disregarding control signals addressed to the other dispenser units. The connection may be by USB, ethernet or other serial connection.

### BACKGROUND OF THE INVENTION

This invention relates to dispensing mechanisms, and is more particularly directed to devices for vending items, for example, pre-paid debit cards (such as telephone long-distance calling cards) when a customer has provided funds to the vending mechanism, e.g., by means of a credit card reader, debit card reader, or a coin and/or currency acceptor device. The invention is more specifically directed to a card vending machine, or an arrangement for dispensing other articles for purchase, which employs a small computer or PC, a customer interface by means of which the customer can select from various articles for purchase, and a plurality of vending units dispensing the respective articles of merchandise.

Self-service card vending can be offered where customers may require any of various items. For example, a customer may require a phone card or a prepaid debit card, which may have a value of e.g., $5.00, $10.00, or $25.00. In a transportation environment, a customer may require a ticket for a mode of public transportation, such as a bus or train, and the value of the ticket may vary with destination, and whether the train or bus is a local or express. Accordingly, there is a need for a card dispenser that is flexible in the number and prices of tickets or cards that are offered to the customer. In addition, the selection and dispensing of the tickets cards or other articles should be simple and reliable.

The current state of the art in card vending mechanisms requires each card dispenser to be interfaced with a main control board that is in turn connected to the currency acceptor or coin acceptor and to the host computer. The card venders are set up to dispense a single debit card when the control board provides the dispenser with an impulse. For example, the customer inserts a ten-dollar bill into the currency acceptor, and the card dispenser dispenses a card carrying ten dollars of long distance service, e.g., thirty minutes of calling time. The card dispensing machines can, for example, dispense any of several values of card, e.g., a twenty-five dollar card, a ten dollar card and a five dollar card. The dispenser has separate card dispensers for the five dollar cards, for the ten dollar cards, and for the twenty-five dollar cards, with each dispenser containing a respective supply of these phone cards.

Card dispensers and similar vending machines have attempted to simplify the vending operation and so there have been proposals for new ways to meet the interface requirements between the computer and the dispensing devices withing the housing or cabinet of the vending machine. One such proposal is found in Smolen et al. U.S. Published Application U.S. 203/0149827. The Smolen et al. Publication proposes the use of a Multi-Drop Bus Protocol or MDB to combine a number of vending devices on a multi-drop bus. However, because of incompatibilities between the standard MDB bus and the serial bus (RS-232 or USB, for example) personal computer interface, either a standard vending machine controller board is required, or an interface unit that is proposed in the publication. This additional interface is necessary because prior card dispensers (or other merchandise article dispensers) have been designed to rely on complex signal interfaces to perform their various card dispenser functions.

Current models of vending machines require a vending machine controller as an interface between the payment accepting elements, e.g., coin acceptors, smart card readers, currency acceptors, card swipe devices, and the like; and product vending units, which may be via the MDB or multi-drop protocol interface standard. However, the vending machine controller circuit board is an additional element, representing space and expense, and also limiting the potential for direct communication between the computer and the vending units.

The problems inherent in the prior art dispensers and their interfaces and controls are as follows:
requirement for a dedicated controller to activate and read signals between the controller and the card dispenser;
requirement for a bulky USB or serial adapter to interface to the card dispenser complex signal interface for creating and interpreting actuating and status signals;
lack of portable apparatus interface techniques and inability to interface to existing off-shelf host controller devices;
inability to activate the card dispenser units manually.

In addition, the software installed in current vending machines does not have the capability to control the multiple vending units directly, nor was it possible to control a large number of vending or dispensing units from a single customer interface.

### OBJECTS AND SUMMARY OF THE INVENTION

Accordingly, it is an object of this invention to provide a self-service vending station for dispensing tickets, phone cards, or other merchandise items, and which avoids the drawbacks of the prior art.

It is another object to provide a self-service vending station that employs a customer interface, such as a touch-screen monitor, a means for accepting customer payment, such as a credit card reader, bill acceptor, coin acceptor, or the like, a host computer, and a number of dispensing units within the vending station cabinet, and which are connected to the computer and controlled directly without an intervening vending machine controller board.

It is a related object to provide an improved dispenser for cards, or for other merchandise articles (e.g., candy bars or soft drinks), and which has a provision for connecting via a USB port, a serial connector, or a network (ethernet) port directly to the computer, or through a standard hub or router.

It is a further object to provide the dispenser with a provision for manual actuation, e.g., an on-board dispense push button.

In accordance with an aspect of the present invention, a dispenser unit is controlled directly from a computer device without an interface circuit board between them. The dispenser has a chamber or equivalent means that holds a supply of cards or other articles of merchandise to be dispensed to the customer. A motor driven mechanism or other electrically powered actuator is rotated in a dispense cycle to dispense one of the articles per dispense cycle. A circuit board is incorporated within the dispenser unit, and is coupled to the actuator to provide electrical drive power to the actuator when a dispense command from the computer device and is received that is addressed to article dispenser. A serial port or connector on the unit is either mounted on the circuit board or connected to it. This port is connected via a computer cable to the host computer so that the dispenser can communicate directly with the host computer device. The circuit board includes a control IC (integrated circuit), e.g., a microcontroller, adapted to recognize the control signals that are addressed to the dispenser device and to disregard control signals addressed to other dispenser devices.

Preferably, the serial connector or port may includes a USB port. Alternatively, the port may be an ethernet port or other connector.

The dispenser unit preferably includes a dispense test button connected to the circuit board to permit manual initiation of a dispense cycle. The dispenser units are preferably powered independently of the computer so they do not receive power through the serial connector. For that reason, a power connector is for connecting to an independent external source of electrical power for the actuator.

In one preferred embodiment, the dispenser includes a housing that is adapted to contain a stack of flat cards, such as prepaid phone cards, transportation tickets or event tickets, or the like. In other embodiments, the dispenser may incorporate a spiral coil dispensing arrangement, for example for a candy vending machine or another similar vending machine. Many types of article dispensers are possible besides these.

A status detector indicates the presence or absence of articles in the dispenser. A jam detector indicates operational status of the dispenser.

A preferred embodiment of a vending machine of this invention permits the customer to purchase articles from a plurality of article dispenser units within the vending machine. The vending arrangement has a computer device, e.g., a Windows-based PC, situated within the housing or cabinet of the vending machine. (The host computer could instead be a Macintosh, Unix-based, Linux-based, or other computer.) There are any number of article dispenser units within the cabinet. Each article dispenser contains a respective supply of articles, i.e., cards or other merchandise. As mentioned above, the article dispensers each have an actuator mechanism for dispensing merchandise articles upon a respective command from the computer device. There is a port or connector accepting a respective serial cable that is coupled to the computer device; and an internal circuit board that includes an IC that recognizes control signals from the host computer device addressed to the respective dispenser, but disregards control signals addressed to the other article dispensers. The internal board then provides actuating drive power to the actuator mechanism. A customer interface permits the customer to select an article for purchase. This customer interface can be based on a touch-screen monitor, with soft buttons used for selection. The interface also indicates the level of funds deposited or credited to the customer and available for making a purchase. The vending machine also includes a mechanism for accepting payment from the customer, such as a credit/debit card reader, coin acceptor, currency acceptor, or other mechanism that permits the customer to pay for the merchandise he or she is going to purchase. This could include a smart-card reader, RFID reader, or other alternative device.

The internal host computer device is suitably programmed to read the customer's selections on the touch-screen monitor (or keyboard or other device), and sends the command signals via the USB port (or ethernet or other serial connection) to the appropriate dispensing unit so that the vend operation will deliver the merchandise to the customer.

The above and many other objects, features, and advantages of this invention will be better understood from the ensuing detailed description of a preferred embodiment, which should be read in conjunction with the accompanying Drawing.

### BRIEF DESCRIPTION OF THE DRAWING

FIG. 1 is a rear perspective view of a card dispenser according to one preferred embodiment of this invention.

FIG. 2 is a front perspective of the card dispenser.

FIG. 3 rear elevation of the card dispenser, showing test button, USB port, and external power connector interface.

FIG. 4 is a bottom view of the card dispenser.

FIG. 5 is a flowchart of the card dispenser control status loop.

FIG. 6 is a flowchart showing card dispenser operation.

FIG. 7 is a front elevation of a vending machine according to an embodiment of this invention, including a touch screen monitor.

FIG. 8 shows a touch screen monitor employed in embodiments of this invention.

FIG. 9 is a front elevation of a vending machine according to another embodiment.

FIG. 10 is a schematic showing a number of vending dispensers coupled via cable directly to a controlling computer device.

FIG. 11 is another schematic showing a number of vending dispensers coupled via cable directly to a controlling computer device.

### DETAILED DESCRIPTION OF THE PREFERRED EMBODIMENT

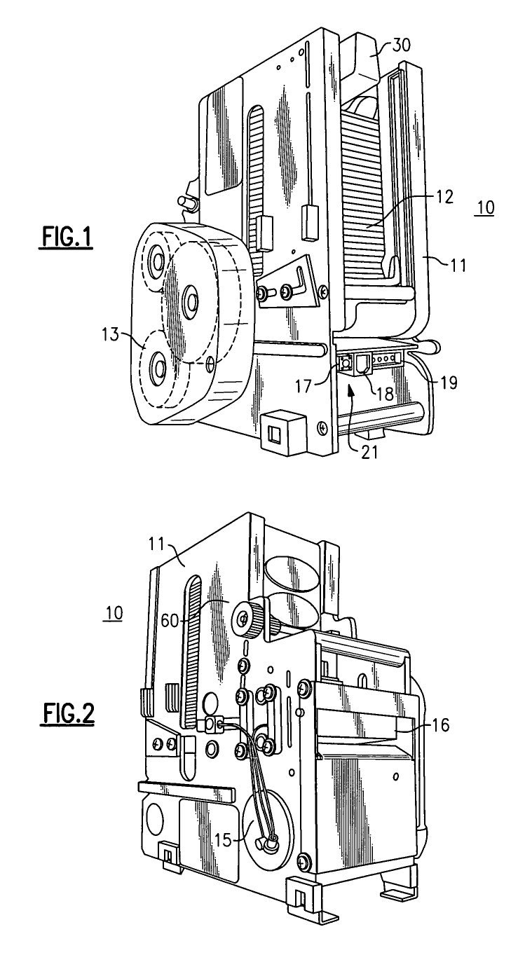

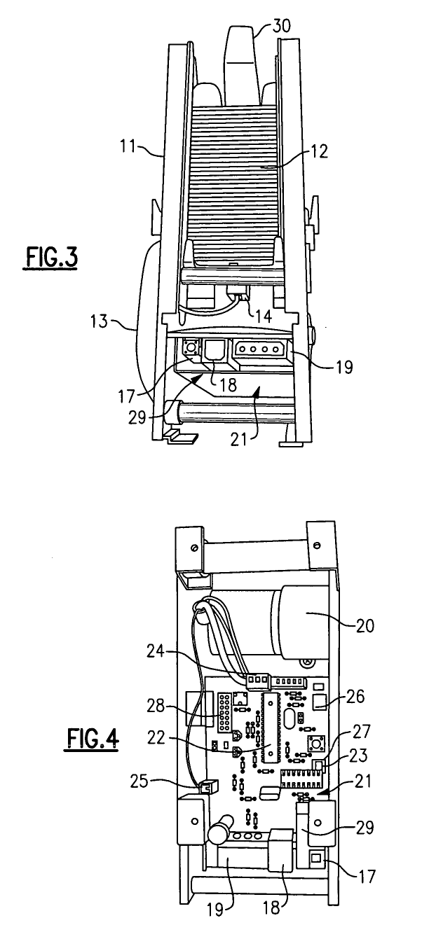

With reference to the Drawing, FIGS. 1 to 4 show a card dispensing or vending unit 10 according to one embodiment of this invention, which permits a customer to purchase a prepaid phone debit card at given value, e.g., $1, $2, $5, $10, $20, $30, $50, or $100. The customer can purchase the card with paper currency or, with a combination of paper currency and coins, or by using a credit card or debit card. The card dispenser 10 is similar to that shown and described in Rademacher et al. U.S. Pat. No. 5,868,237, but with additional features such as an on-board circuit board, a manual dispense push button, and connectors or ports for coupling a USB connector or ethernet port, or other serial connector. U.S. Pat No. 5,868,237 is incorporated herein by reference.

In this embodiment, the card dispensing unit 10 has a housing or frame 11 that contains a stack of flat, rigid cards, e.g., long distance phone cards 12. A gear drive mechanism 13 is shown here on one side of the housing 11, comprising gears that rotate drive rollers for dispensing the cards one at a time.

An empty-card detector 14, here in the form of a microswitch, is provided to close when the last card is dispensed. A sensor array 15 is situated on one side of the housing, as shown in FIG. 2, to communicate machine status to the internal controller board which is to be discussed shortly. A card exit slot 16 is provided at the front or distal side (FIG. 2) and the card exits here during a dispense cycle. The card may be held in the slot (to be pulled out by the customer) or may be ejected to fall into a bin. The held or ejected setting can be established by means of a jumper on the internal control board, or may be established in software.

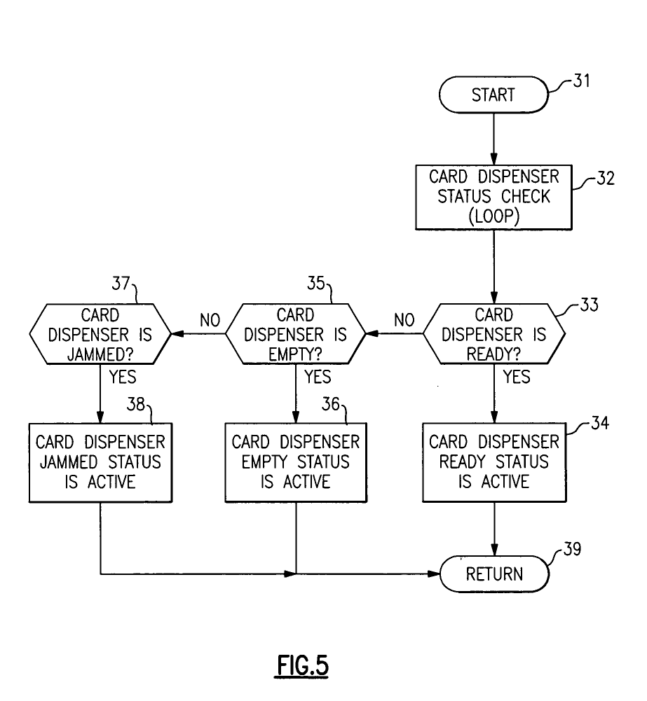

At the back or rear-facing side of the dispenser 10 is a dispense test button 17, which can be depressed manually (by authorized personnel) to initiate a dispense cycle. A serial USB “B” port 18 is also placed here to connect by means of a standard USB cable with the main vending machine host computer. Also shown here is an external power connector 19, connecting via a power cable (not shown) to an external DC power source, which provides the required levels for operating a reversible DC motor 20 (FIG. 4). This may include +12 volts, −12 volts, and ground. The motor 20 propels the card drive rollers, which are discussed in more detail in the earlier U.S. Pat. No. 5,868,237. The motor power is preferably provided separately from the USB port, but in some applications the power may be derived from the USB port.

An on-board electronics controller board 21 is dedicated to the associated vending unit 10. The board 21 slides into the base of the housing 11. The dispenser button 17, the USB port 18 and the power connector 19 are located here. A microcontroller EPROM 22 is present on the controller board 21 for communicating via the USB port. There is another multi-pin socket 23 into which another IC, e.g., a microcontroller EPROM, can be installed for network, i.e., ethernet applications. Also shown on the board 21 are a motor drive interface 24, a sensor interface 25, a ready/empty LED signal interface 26, and an empty switch interface 27. The interface 26 controls a status LED 26A. A jumper board 28 allows the vending company personnel to reconfigure the machine for desired functions, e.g., to dispense and hold the card or to eject the card, as mentioned above. An ethernet port 29 is provided on the board (See FIG. 4).

The on-board circuit board 21 for each dispensing unit permits the vending computer to connect directly via serial cable with each of the dispensing units. No intermediate controller board is required, in contrast with the current practice, nor is there a need for the special interface unit that is required for the MDB protocol discussed earlier.

A card weight 30 is shown here on top of the stack of cards 12, and serves to keep the cards properly stacked in place in the housing 11. Another possible hold-down arrangement, e.g., spring loaded, could be used instead. Other features here include a knob 60 for adjusting the rollers for the thickness of the cards or other flat articles that are to be dispensed.

The card dispenser interface control board 21 directs the control of logic control and communications circuitry to monitor and control the dispenser unit using the dispense test button 17, USB port 18, and/or serial (ethernet) port 29. The interface control board 21 controls the motor 20 through the motor drive interface 24. The interface control board 21 monitors card transport path through the sensors 14, 15, etc. through the sensor interface 25 and empty switch interface 27, and provides a read/empty/jammed LED/signal status through the Ready/Empty interface 26. The card dispenser interface control board 21 is provided with meters to count the total number of dispenses or vend operations and provides those counts on request via the USB port 18 or serial port 29. The meters are stored on the EPROM inside the microcontroller 22.

The card dispenser interface control board 21 has a configurations options for adjusting its parameters such as “Card Hold”, “Number of Retries” or other control related settings. These can be set on the jumper board 28 or programmed and stored inside the EPROM microcontroller 22. The microcontroller can also store commands that request specific tasks, such as “Dispense Card”, “Request Status”, “Read Total Dispense Count Meter”, “Read/Write Total Number of Retries”, Reset Card Dispenser”, and “Read/Write Card Hold Settings”; these can be changed or installed from the host computer via the USB port 19 or serial port 29.

The microcontroller 22 can employ a standardized embedded control program for communications and logic control with a suitable programming so that all the functions indicated can be carried out. A dispense counter is incorporated into the firmware or embedded software, and keeps track of the total number of dispenses on the associated dispense unit, based on both the actuations of the dispense test button and requests by the host computer. This counter can be queried by the host computer, and can be reset. Thus, the number of dispenses for each respective dispenser in the array of dispenser units is tracked on the individual dispenser unit.

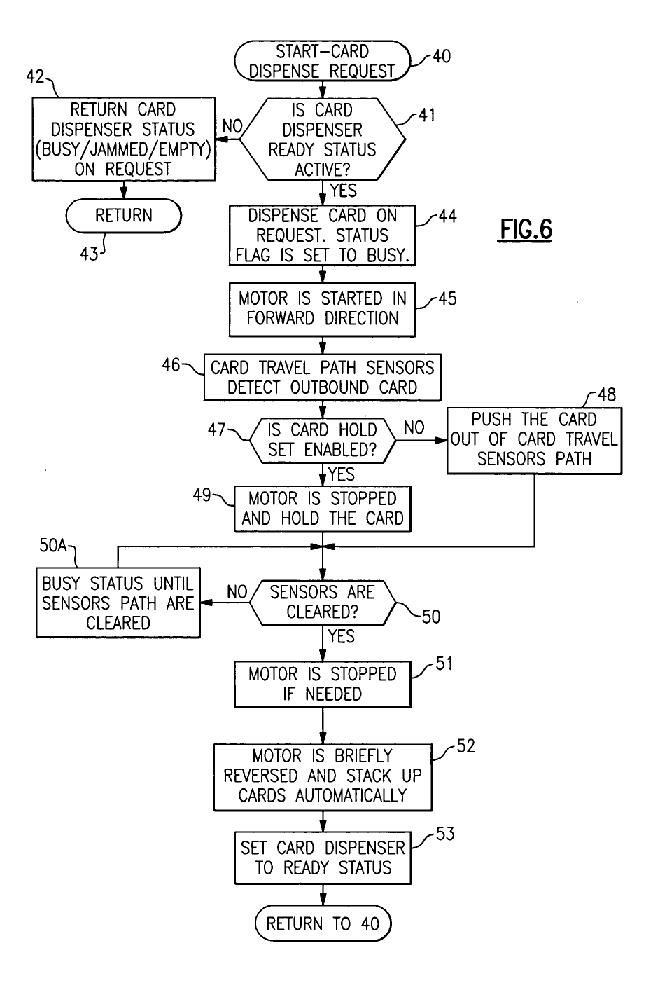

The main operation of the dispenser 10, as carried out by the embedded program on the microcontroller 22, can be explained with reference to the flow chart illustrated in FIG. 5. Specifically, when the dispenser control board 21 is activated (step 31), the program starts an Apparatus Status Check loop 32 to monitor the signals coming from both card transport path sensors and the empty card switch 14. When the sensors 14, 15 are all in the normal state, i.e., where the exit slot 16 is not jammed and the card detector 14 indicates the presence of cards in the stack 12 (step 33), then the dispenser is ready for a dispense operation and the controller board goes to a Dispenser Ready Status 34. If the switch 14 is open due to there being no cards in the stack 12, a Card Dispenser Empty Status is detected (step 35), and the controller board 21 sets a status flag to EMPTY to indicate a Card Dispenser Empty Status 36. This turns on the pilot light or LED status indicator 26A to show the EMPTY status. If the transport path sensors 15 are covered, and a card jam is detected (step 37) the card dispenser 10 will attempt to clear the card by pulling the card back into the card stack 12. Several attempts are made. If the clear card path attempt fails, a card jam is indicated, and the status flag is set as JAMMED, i.e., JAMMED status is considered active(step 38). This causes the LED status indicator 26A to flash on and off to indicate a card jam. To clear the JAMMED status, the operator may need to reset the dispenser by depressing the reset button or manual dispense button 17. Alternatively, the operator can send a reset command from the host computer via the USB port 18 or linear port 29.

The System Ready, Empty, Jammed status signals change the illumination state of the LED indicator 26A, which can have several flashing/steady states. Preferably, a bi-directional LED is used so the color can be changed as well. In one preferred mode, the LED can have the following status indications:
Steady ON (Green)=“Ready”, i.e., the dispenser is ready for a card dispense operation.
Steady ON (Red)=“Empty”, i.e., stack 12 is out of cards.
Blinking (Red)=“Jammed”, i.e., a card is stuck inside the card dispense transport path.
OFF=Busy/Not in Service.

The routine reaches a RETURN step 39 which re-initiates the Status Check loop 31, and also links to the Start Card Dispense Request 40 (FIG. 6) or dispense operation start position.

The card dispense request commences after a card dispense command is received (via port 18 or 39) from the host computer, or by the operator depressing the dispense button 17 on the back of the card dispenser controller board 21.

The program routine first checks the ready status of the dispenser (step 41) and if the dispenser is busy, empty, or jammed (STEP 42), the system returns (step 43) to the Status Check loop of FIG. 5. Otherwise, the card dispense operation is commenced, setting the status flag to BUSY (step 44) and turning off the LED indicator 26A. Motor power is switched ON (step 45), starting the motor 20 in the forward direction. The bottom card in the stack 12 is propelled forward through drive rollers towards the exit slot, past the card transport sensors 15 until those sensors detect the presence of the card (step 46). The program checks to see if the CARD HOLD setting has been enabled (step 47). If the CARD HOLD setting has not been enabled the motor continues to run (step 48) until the card has been pushed out through the slot 16 and falls into a receptacle or bin. The motor continues to turn the rollers until the card completely clears the sensors 15. If CARD HOLD has been enabled (step 49), the motor 20 is stopped with the card protruding through the exits slot, with the dispenser holding the card until the customer pulls it out. After a dispense operation, the program checks the status of the card path sensors 15 (step 50), and until the sensors indicate the path is clear, a BUSY status is maintained (step 50A). This means that in the CARD HOLD setting, the system will remain in the BUSY status until the customer physically pulls out the card that he or she has purchased.

After the card has been removed or ejected, and the sensors 15 are cleared (step 50), the motor 20 is stopped if needed (step 51), and then the motor is reversed briefly (step 52), i.e., for approximately one second. This action stacks up the remaining cards 12 and ensures that the card empty switch or detector 14 remains closed (i.e., not in the EMPTY state). Then, the card dispenser returns to READY status (step 53). The controller program returns to the Card Dispense Status Check routine 40. If the last card has been dispensed, the card empty switch 14 detects no card is present, then the dispenser goes to EMPTY status.

In order to accommodate a variety of interface requirements for vending of merchandise articles where an array of card dispensers (or another type dispenser operating on the same principle) is used, the card dispenser interface control board 21 that is contained internally within the dispenser should include a variety of interface data formats as may be required by the host computers. For example, the card dispenser 10 may be employed in vending machines (e.g., pre-paid phone card dispensers), slot machines or gaming machines, entry control devices (e.g., ticket dispensers or token dispensers for bus, train, ferry or subway services) where there is a host computer, a customer interface (e.g., keypad or touch screen), and at least one article dispensing unit. In the case of a vending machine, a PC power supply can be employed for powering the dispensing unit(s), and an industry-standard XT style power connector may be used to connect the power cord to the connector 19 of the card dispenser or other article dispenser. The vending machine may employ standard data interface(s) employing standard interface specifications, such as ethernet, universal serial bus (USB), TTL serial, RS232, RS485, to connect with the card dispenser and transmit the commands from the computer and receive status messages from the card dispenser. The dispensers of this invention may also be employed in a vending machine employing MDB (multi-drop bus) protocol.

The card dispenser internal controller board may be installed into a local area network (LAN) through the ethernet port 29 using a serial-ethernet bridge interface. Alternatively, the card dispenser may be interconnected with other devices, including the system computer, using a USB (universal serial bus) connector. The USB system is used to interconnect a number of external USB devices to the computer using a single USB bus. In the case of the card dispenser arrangement as shown here, an external multi-port USB hub may be provided as part of the USB bus to expand the number of card dispensers that can be controlled from a single computer. Currently, the USB connectivity makes it possible for the computer to control up to 255 different card dispensers, which makes a wide variety of purchases possible for the vending customer.

In the card dispenser embodiment, the card dispenser controller board 21, with the microcontroller 22 and the USB interface port 18, may be programmed to accept and/or transmit formatted self-descriptive command data packets, or HID report descriptors. These are discussed in detail in the publication, “The Device Class Definition for Human Interface Devices, Firmware Specification”, Version 1.0—Final USB Implementers Forum, 1997. As is well understood in the art, an interpretive interface communication software driver within a host computer of any connected device contains and/or uses a library of pre-defined peripheral device USB drivers to control the USB-based card dispenser.

Card dispensers 10 with USB port 18 or serial port 29 allow multiple card dispensers to be installed within the housing or cabinet of the same or another device such as a vending machine. The dispensers can be installed in any configuration without the need to activate software routines to install the card dispenser on the host computer. In this case, the card dispenser 10, through the USB port 18 or the ethernet connector 29, automatically registers with the host computer upon startup, and during operation periodically transfers status message packets to the host computer. Furthermore, the use of the USB or serial port obviates any need for the user or operator for a special multi-port communication hub or vending controller board, and permits service of each card dispenser from the central host computer.

In other embodiments, the dispense test button 17 can be arranged to permit direct request for the card dispenser to dispense the card automatically. This feature permits the operator to adjust the card gate height at the exit slot 16 by adjustment of the card-thickness adjustment knob 60 on the side of the dispenser 10 (FIG. 2). This permits the card thickness adjustment to be made on the fly to ensure the card gate thickness is properly adjusted before the dispenser or vending machine is put into use.

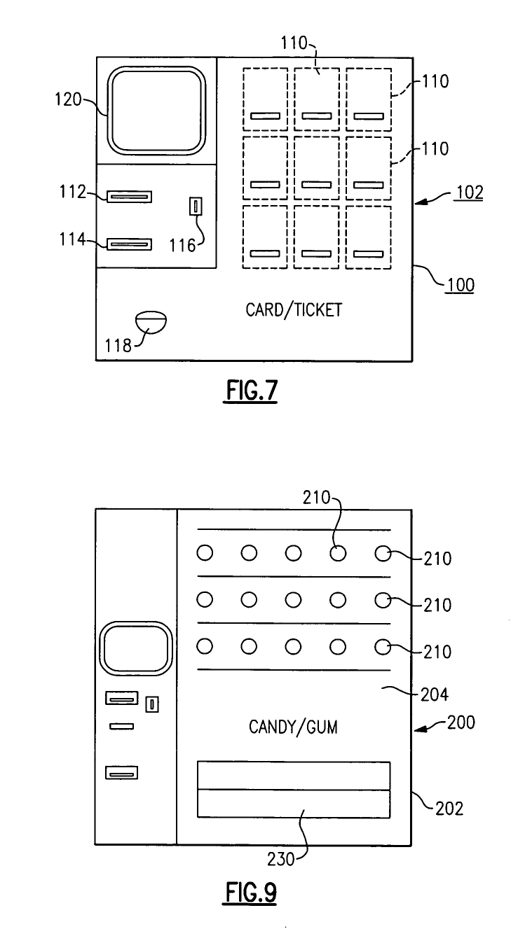

With reference to FIG. 7, a multi-selection card vending machine 100 is shown here, having a cabinet 102 and with an array of card dispensers 110 of the type just described situated behind the front panel of the cabinet. Each dispenser 110 holds a supply of cards in a stack, and dispenses them one at a time through the front panel of the cabinet. These cards may be prepaid phone cards of various values, or may be tickets for public transportation, for example. Also shown in the front of the vending machine, here to the left of the array of dispensers, are a currency or bill acceptor 112, a credit card reader 114, here shown as a “swipe” reader, and a coin acceptor 114. The machine can also have a change-making capability, and in that case can include a change dispenser 118. The change dispenser can be of a known design, and can have a capability of dispensing some combination of coins, e.g., dollar coins, quarter-dollars, dimes, nickels, and pennies.

A touch screen monitor 120 is built into the machine, and here serves as customer interface. This connects with a computer device (not shown here) that is contained within the cabinet 102. Indicia appear on the monitor 120 to indicate the amount of customer credit available, i.e., how much money has been inserted, and soft buttons that permit the customer to choose the items to be purchased. One example of a screen as viewed on the touch screen monitor is shown in FIG. 8.

On the touch screen 120, any of a number of legends, instructions, and soft push buttons can appear depending on software in the host computer. In this example, at the lower left of the screen 120 is a legend 122 instructing the customer to swipe his or her credit card (e.g., in the reader 114). The amount of credit available for the customer then appears on a cash balance window 124. Alternatively, the customer can insert bills and coins into the bill acceptor 112 and coin acceptor 116, and the amount inserted will appear on the window 124. A series of soft touch buttons 126 to 140 appear on the right hand side of the screen, the number depending on the number of available selections. In this example, the vending machine 100 is set up for vending ride or passage tickets, with different tickets at different prices. Here, the button 126 is for the express bus on route # 10, with a ticket price of $14.30, and just below that the button 128 shows the ticket price for the express bus on route #5 to be $7.15. The remaining buttons show the other routes available as express and local on each route, or as a loop ride (buttons 138, 140). As many soft push buttons can be provided as needed, as they are created in software on the host computer, and each may correspond to a given one of the dispenser units 110. For some of the higher demand ticket values, there may be two dispensers controlled by the same button, with one dispensing after the other reaches EMPTY status.

Also shown here on the touch screen are buttons for customer HELP, and for language selection (English/Spanish). Many other options can be provided. The operator may call up an administration/system maintenance screen (not shown) to change the ticket prices or to add tickets for other routes.

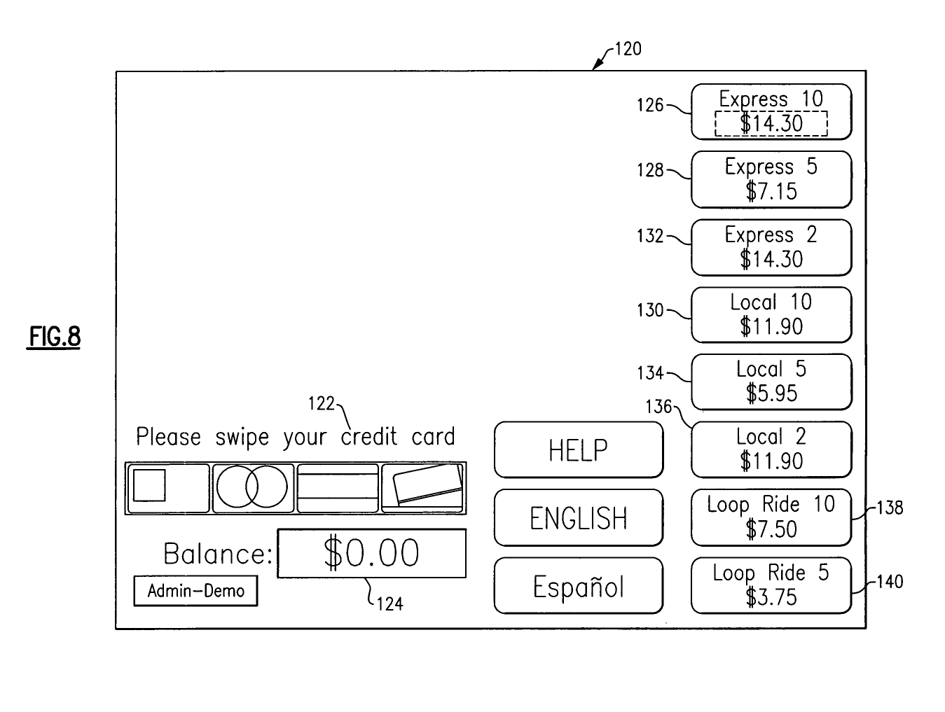

The same general principles of this invention can be employed in other vending environments, including, for example, a glass-front vending machine for selling candy or snack foods, shown as vending machine 200 in FIG. 9. Here, the vending machine has an enclosure or cabinet 202 with a front panel 204 of glass or other transparent materials, and with an array of spiral vending dispensers 210, 210 mounted within the cabinet and visible through the glass front panel 204. In this embodiment, each spiral dispenser has a coil that can hold a candy bar, potato chip bag, or other item; when the item is purchased, the coil rotates 360 degrees, dropping the article into a bin 230 at the base of the vending machine. In the case of a spiral vending dispenser 210, there can be a pair of dispensing coils operated from a single circuit board 21 connected to the computer via a single USB or network connection. The command for rotating the motor in the forward direction in the card dispensing embodiment would rotate one of the two coils, and the command for rotating the motor reversely would rotate the other coil. This makes it possible for up to 2×255 or 510 different types of article to be dispensed from a single vending machine, using USB technology.

Moreover, while the vending machines shown in FIGS. 7 and 9 show the dispensing units all within a single cabinet, it is certainly within the scope of the invention for the computer and customer interface to actuate dispensing units in two or more different cabinets.

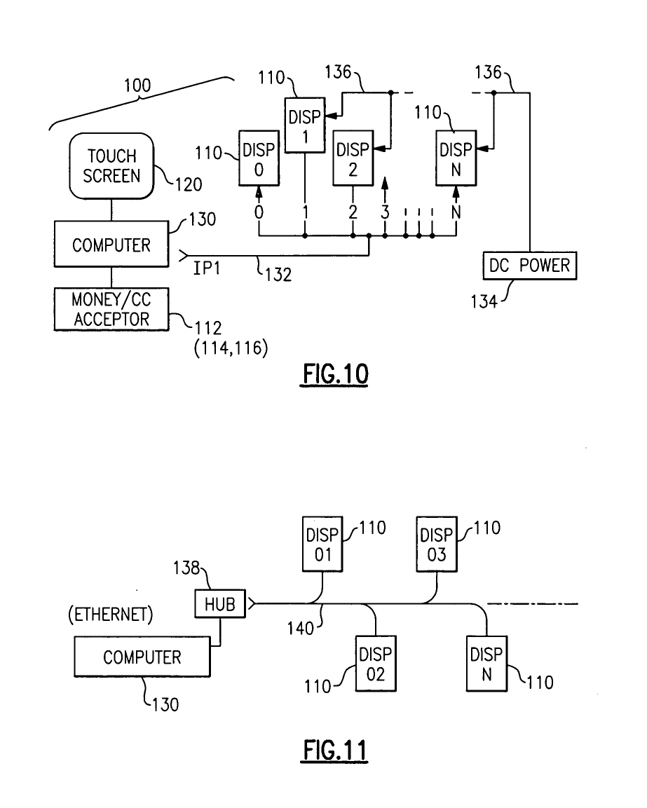

A general schematic of the system of the vending machine 100 of the FIG. 7 embodiment is shown in FIG. 10. Here, the touch screen customer interface 120 and money acceptor equipment 112 (and/or 114, 116) are connected to the host computer 130, which is situated inside the cabinet. The array of dispensers 110 are connected via USB cables 132, either connected directly to a computer port IP1 or connected through a USB hub (not shown). Each dispenser unit 110 has a separate electronic identity, represented here as numbers 0, 1, 2, etc. through N, and these identities are stored in the host computer 130. Each dispenser receives and accepts commands from the computer that are transmitted with the dispenser unit's address but does not respond to those with addresses for the other dispenser units. Also shown here is an external power supply 134 that supplies DC motor power via a power cable 136 to each of the dispensing units 110. As mentioned above, the vending units need not all be within the same cabinet, and some may be located remotely, if a remote dispensing application is needed. In that case, there may be a supplemental power supply for the remote dispenser or dispensers.

FIG. 11 illustrates schematically the alternative arrangement in which the host computer 130 connects via a local network (e.g., ethernet) with the dispenser units 110 in the array. Here is shown a network hub 138 with ethernet cabling 140 leading to the various dispensers 110. The other associated devices such as the touch screen customer interface and the money and credit card acceptors although not shown here would be connected in a convenient fashion to the host computer 130.

It is possible to employ other serial connectors, rather than those specifically discussed here, e.g., using the RS 232 protocol.

It should be understood that many items other than phone cards can be dispensed in this arrangement, for example, lottery tickets or cards; bus, train, or subway tickets; postage, etc. Also, the currency acceptor could be adapted to accept currency of two different countries, e.g., U.S. and Canada, for example at border crossings and at airports. The software in the host computer in that case could be suitably programmed to assign the proper exchange rate to the currencies.

There are many variations of the vending station which incorporate the features and advantages mentioned above. While the invention has been described with reference to a few preferred embodiments, it should be recognized that the invention is not limited to those precise embodiments. Rather, many modifications and variations would present themselves to persons skilled in the art without departing from the scope and spirit of the invention, as defined in the appended claims.

I claim:

1. Article dispenser controlled directly from a computer device without a vending machine interface circuit board therebetween, comprising:
means holding a supply of articles of merchandise to be dispensed;
an electrically powered actuator that is rotated in a dispense cycle to dispense one of said articles per dispense cycle;
a circuit board within the dispenser coupled to said actuator to control application of electrical power to said actuator upon receipt of a dispense command sent by the computer device to said article dispenser;
a serial connector adapted to connect with a computer cable to communicate with said computer device; and
said circuit board including a control circuit adapted to recognize control signals addressed to the dispenser device and to disregard control signals addressed to other dispenser devices.

2. Article dispenser according to claim 1, wherein said serial connector includes a USB port.

3. Article dispenser according to claim 1, wherein said serial connector includes an ethernet port.

4. Article dispenser according to claim 1, further comprising a dispense test button connected to said circuit board to permit manual initiation of a dispense cycle.

5. Article dispenser according to claim 1, further comprising a power connector for connecting to an external source of electrical power for said actuator.

6. Article dispenser according to claim 1, wherein said means for holding a supply of articles includes a housing adapted to hold a stack of flat cards.

7. Article dispenser according to claim 1, wherein said means for holding a supply of articles includes a spiral coil dispensing arrangement.

8. Article dispenser according to claim 1 further comprising a status detector to indicate the presence or absence of article in said supply.

9. Article dispenser according to claim 1 further comprising a jam detector to indicate operational status of said dispenser.

10. Article dispenser according to claim 1 wherein said circuit board within the dispenser includes a counter means for tracking the number of dispenses carried out by the dispenser.

11. A dispensing arrangement for permitting a customer to purchase articles from a plurality of article dispenser units; comprising:
a cabinet;
a host computer device within said cabinet;
a plurality of said article dispenser units within said cabinet; each said article dispenser unit containing a respective supply of said articles; actuator means for dispensing one of said articles upon a respective command from said computer device; a connector receiving a respective serial cable coupled to said computer device; and an internal circuit board for recognizing control signals from said host computer device addressed to the respective dispenser unit and not responding to control signals addressed to the other ones of said article dispenser units;
a customer interface permitting the customer to select an article for purchase; and
means for accepting payment from said customer.

12. The dispensing arrangement according to claim 11 wherein said customer interface includes a touch screen monitor mounted in said cabinet.

13. The dispensing arrangement according to claim 12 wherein said touch screen monitor presents a plurality of touch buttons corresponding to associated ones of said article dispensers.

14. The dispensing arrangement according to claim 11 wherein said means for accepting payment includes a credit card acceptor.

15. The dispensing arrangement according to claim 11 wherein said means for accepting payment includes a cash acceptor.

16. The dispensing arrangement according to claim 11 wherein at least some of said article dispenser units include card dispensers.

17. The dispensing arrangement according to claim 11 wherein at least some of said article dispenser units include spiral coil dispensers.

18. The dispensing arrangement according to claim 11 comprising a cable arrangement directly connecting said dispenser units with said host computer.
